(19) United States
(12) Patent Application Publication
(10) Pub. No.: US 2026/0140336 A1
(43) Pub. Date: May 21, 2026

(54) OPTICAL TRANSMISSION DEVICE

(71) Applicant: AIP Inc., New Taipei City (TW)

(72) Inventor: Chia Lee, New Taipei City (TW)

(21) Appl. No.: 19/259,403

(22) Filed: Jul. 3, 2025

Related U.S. Application Data
(63) Continuation-in-part of application No. 18/510,668, filed on Nov. 16, 2023.
(60) Provisional application No. 63/528,933, filed on Jul. 26, 2023.
(60) Provisional application No. 63/781,378, filed on Apr. 1, 2025.

(51) Int. Cl. G02B 6/42; G02B 6/38

(52) U.S. Cl. CPC G02B 6/424; G02B 6/387; G02B 6/3882; G02B 6/3893; G02B 6/4228

(57) ABSTRACT

An optical transmission device includes a photonic integrated circuit, a first connecting unit, and a second connecting unit. The photonic integrated circuit includes a main substrate and a waveguide integrally protruding from the main substrate and comprising a plurality of waveguide paths. The first connecting unit includes a plurality of optical fibers and a ferrule element positioned at end portions of the optical fibers. The second connecting unit is positioned between the main substrate and the first connecting unit. The optical fibers are in optical alignment with the waveguide paths through a detachable connection of the first connecting unit to the second connecting unit.

### CROSS REFERENCE TO RELATED APPLICATIONS

This application claims the benefit of U.S. provisional patent application Ser. No. 63/781,378, filed Apr. 1, 2025, the entirety of which is incorporated by reference herein.

This application is a continuation-in-part of Ser. No. 18/510,668, filed Nov. 16, 2023, which claims the priority of U.S. provisional patent application Ser. No. 63/528,933, filed Jul. 26, 2023, the entireties of which are incorporated by reference herein.

### BACKGROUND OF INVENTION

### 1. Field of Invention The present invention relates to a technical field of optical transmission, and particularly to an optical transmission device.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and may be co-packaged as co-packaged optics (CPO).

Generally, optical fibers are connected between photonic integrated circuits of conventional CPO devices and applied devices for optical transmission. Ends of optical fibers are equipped with connectors to be in direct contact with and firmly fixed with photonic integrated circuits. However, the firm fixing between optical fibers and photonic integrated circuits is not suitable for replacement of optical fibers when the optical fibers are broken. Further, additional lens or optical waveguide devices may be provided to couple with photonic integrated circuits to align with optical paths one by one, lens seats or optical waveguide devices are typically stacked on photonic integrated circuits using adhesive, which often leads to adhesive overflow and misalignment issues and require a wider range between each optical path to apply the adhesive and not conducive to compact components.

### SUMMARY OF INVENTION

An object of the disclosure is to provide an optical transmission device adapted to allow repeated plugging and unplugging of an optical cable with a compact size.

To achieve at least one of the above-mentioned objects, the disclosure provides an optical transmission device including a photonic integrated circuit, a first connecting unit, and a second connecting unit. The photonic integrated circuit includes a main substrate and a waveguide integrally protruding from the main substrate and including a plurality of waveguide paths. The first connecting unit includes a plurality of optical fibers and a ferrule element positioned at end portions of the optical fibers. The second connecting unit is positioned between the main substrate and the first connecting unit. The optical fibers are in optical alignment with the waveguide paths through a detachable connection of the first connecting unit to the second connecting unit.

Optionally, the waveguide protrudes from an edge of the main substrate and extends into the second connecting unit.

Optionally, the second connecting unit includes a base body including a front end, a rear end located opposite to the front end, and two retaining walls. The front end is located on the main substrate. The two retaining walls spaced apart from each other and extending downward from a bottom of the base body. A hollow portion is positioned in the base body between the front end, the rear end, and the retaining walls. The waveguide extends into the hollow portion.

Optionally, the base body further includes a plurality of attaching portions disposed on the retaining walls, the first connecting unit further includes a plurality of positioning elements disposed on the ferrule element, and the positioning elements are sized and shaped to engage with the attaching portions.

Optionally, the base body further includes a mounting portion extending from the front end to the retaining walls and positioned on the main substrate.

Optionally, a front recessed portion is defined between the mounting portion and the retaining walls and has a thickness greater than a thickness of the main substrate.

Optionally, the base body further includes a bottom board connected between the two retaining walls and located lower than the mounting portion, and the waveguide is positioned on the bottom board.

Optionally, the waveguide further includes an optical coupling surface disposed at an end of the waveguide away from the main substrate, the waveguide paths extend from the optical coupling surface to the main substrate, and the waveguide extends out of the bottom board such that the optical coupling surface is located beyond the bottom board.

Optionally, the second connecting unit further includes an engaging member positioned on the rear end of the base body, the first connecting unit further includes a fastening member movably connected to the ferrule element, and the fastening member is detachably engaged with the engaging member.

Optionally, the engaging member includes an engaging protrusion positioned on an upper surface of the engaging member, and the fastening member defines a fastening groove shaped and sized to be in a snap-fit engagement with the engaging protrusion.

Optionally, the first connecting unit further includes a limiting rod and an elastic component, one end of the limiting rod is connected to a rear side of the ferrule element, another end of the limiting rod is connected to a portion of the fastening member, wherein the elastic component is positioned around the limiting rod and is abutted between the rear side of the ferrule element and the portion of the fastening member, and is deformable in length along the limiting rod in conjunction with movement of the fastening member.

The disclosure provides the photonic integrated circuit including the waveguide integrally protruding from the main substrate, which can eliminate the need for additional lens seats or optical waveguide devices for optical coupling and simplify the structure, thereby overcoming the problem of adhesive overflow caused by stacking a lens seats or optical waveguide devices on the main substrate. In addition, the base body of the second connecting unit houses the waveguide for effective protection and is firmly mounted to the photonic integrated circuit through the use of the mounting portion, the retaining wall, and the bottom board, thereby preventing longitudinal and transverse displacement of the waveguide and avoiding damage to the waveguide and the photonic integrated circuit. Furthermore, the engaging member and the fastening member enable a detachable, easy, and reliable connection between the first connecting unit and the second connecting unit, while ensuring precise optical alignment between the waveguide paths and the optical fibers during repeated plugging and unplugging of the optical fibers.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic exploded view of an optical transmission device in accordance with an embodiment of the present application.

FIG. 2 is a schematic partial assembly view of the optical transmission device of FIG. 1.

FIG. 3 is a schematic assembly view of the optical transmission device of FIG. 1.

FIG. 4 is a schematic cross-sectional view taken along line A-A of FIG. 3.

FIG. 5 is a schematic perspective structural view of a first connecting unit in accordance with an embodiment of the present application.

FIG. 6 is a schematic bottom-to-top rear perspective view of the first connecting unit in accordance with an embodiment of the present application.

FIG. 7 is a schematic perspective view of an optical transmission device in a usage state in accordance with an embodiment of the present application.

### DESCRIPTION OF PREFERRED EMBODIMENTS

The following embodiments refer to the accompanying drawings for exemplifying specific implementable embodiments of the present invention. Directional terms described in the present invention, such as upper, lower, front, back, left, right, inner, outer, side, etc., are only directions by referring to the accompanying drawings, and thus the used directional terms are used to describe and understand the present invention, but the present invention is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component, or a first section could be termed as a second element, a second component or a second section without departing from the teachings of the present application.

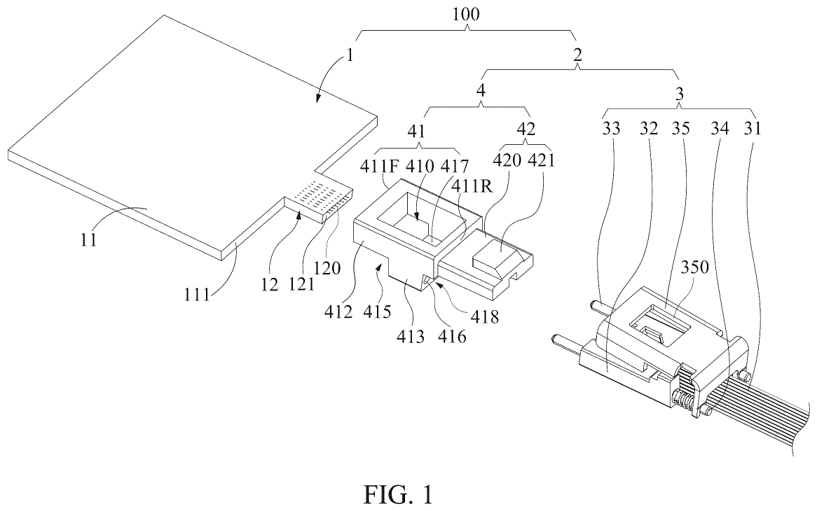

The disclosure provides an optical transmission device, which is disposed in a photonic integrated circuit, an all-optical device such as all-optical switches, all-optical logic gates, all-optical buffers, or all-optical wavelength converters, or a data processing device or a data sharing device, such as switches or servers, etc. Referring to FIG. 1, it shows a schematic exploded view of an optical transmission device 100 according to an embodiment of the disclosure. The optical transmission device 100 includes a photonic integrated circuit 1 and a detachable optical cable 2. The photonic integrated circuit 1 includes a main substrate 11 and a waveguide 12 integrally protruding from the main substrate 11. The detachable optical cable 2 includes a first connecting unit 3 and a second connecting unit 4.

In some embodiments, the photonic integrated circuit 1 is a silicon-based photonic integrated circuit, and preferably, a silicon nitride photonic integrated circuit or a silicon photonic integrated circuit. The photonic integrated circuit 1 may be fabricated using silicon-on-insulator wafers, but not limited thereto. Specifically, the photonic integrated circuit 1 is equipped with a light detection module (not shown) for receiving light signals, a light source module (not shown) for emitting light, and a plurality of active components and passive components (not shown), such as, but not limited to filters or multiplexing structures, optical power distribution structures, optical fiber output and input structure, and light modulation structure on the main substrate 11. Since the active components and passive components of photonic integrated circuits are well known in the art, they will not be described in detail here.

The main substrate 11 and the waveguide 12 are made of a same material. Specifically, the waveguide 12 integrally protrudes from an edge 111 of the main substrate 11 and extends by a preset distance into the second connecting unit 4. As shown in FIG. 1, the waveguide 12 includes a plurality of waveguide paths 120 and an optical coupling surface 121 disposed at an end of the waveguide 12 away from the main substrate 11. The waveguide paths 120 extend from the optical coupling surface 121 to the main substrate 11. Preferably, the optical coupling surface 121 tilts at an angle, preferably eight degrees, in order to reduce light signal loss during optical signal transmission with the optical cable 2. In some embodiments, the waveguide paths 120 may form a planar lightwave circuit (PLC). A plurality of the waveguides 12 may protrude from the edge 111 or other peripheral edges of the main substrate 11, depending on specific requirements. It should be noted that forming the waveguide 12 as an integral protrusion from the main substrate 11 eliminates the need for additional lens seats or optical waveguide devices for optical coupling, thereby reducing light loss.

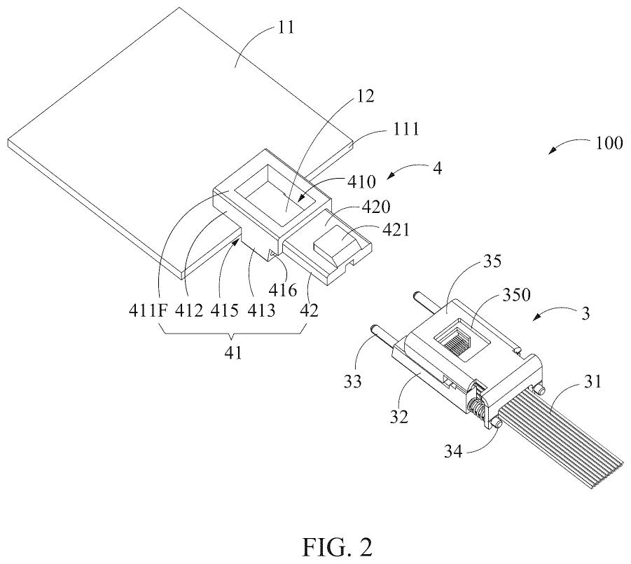

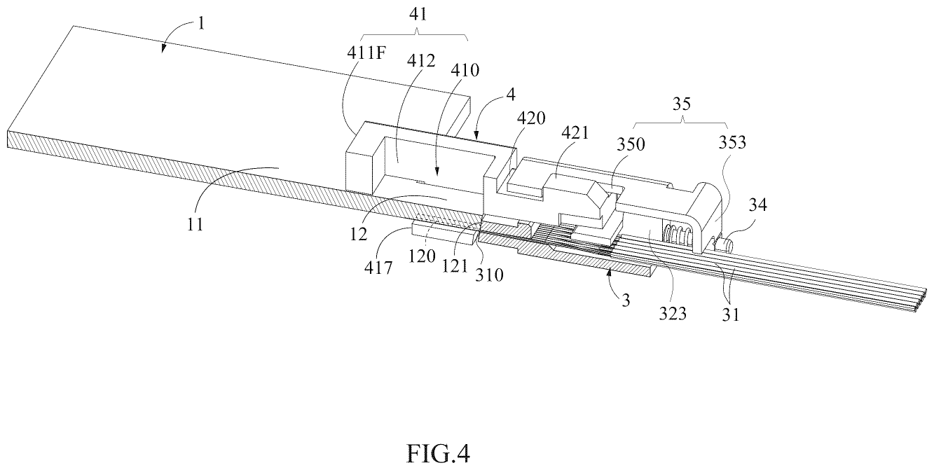

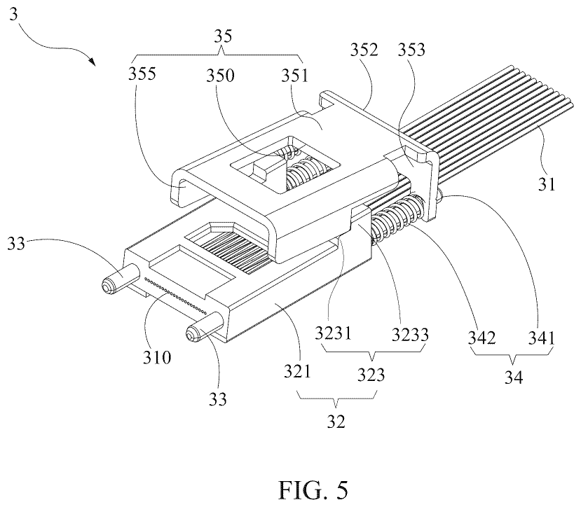

As shown in FIG. 1, the second connecting unit 4 is positioned between the main substrate 11 and the first connecting unit 3 and fixed on the main substrate 11 (please refer to FIG. 2). The first connecting unit 3 is detachably connected to the second connecting unit 4. The first connecting unit 3 includes a plurality of optical fibers 31, a ferrule element 32, two positioning elements 33, two limiting members 34, and a fastening member 35. Specifically, the ferrule element 32 is positioned at end portions of the optical fibers 31, with fiber ends 310 (please refer to FIG. 4 and FIG. 5) of the optical fibers 31 being flush with a front surface of the ferrule element 32. Two positioning elements 33 are disposed on the front surface of the ferrule element 32. In this embodiment, the positioning elements 33 extend frontward from the front surface of the ferrule element 32 and are pin-like in shape. Based on the principle of optical, the front surface of the ferrule element 32 is oblique at an angle, such as eight degrees, to correspond to the optical coupling surface 121 for reducing light signal loss between the optical fibers 31 and the waveguide paths 120. The limiting members 34 are disposed between a rear surface of the ferrule element 32 and a portion of the fastening member 35. The fastening member 35 is movably connected to the ferrule element 32 through the limiting member. A fastening groove 350 is formed on the fastening member 35 facing the ferrule element 32.

Still referring to FIG. 1, the second connecting unit 4 includes a base body 41 and an engaging member 42. Specifically, the base body 41 includes a front end 411F, a rear end 411R located opposite to the front end 411R, a mounting portion 412 positioned on the main substrate 11, two retaining walls 413 spaced apart from each other and extending downward from the bottom of the base body 41, two attaching portions 416 disposed on the retaining walls 413, respectively, and a bottom board 417. In detail, the mounting portion 412 extends from the front end 411F to the retaining walls 413. A hollow portion 410 is positioned in the base body 41 between the front end 411F, the rear end 411R, and the retaining walls 413. Specifically, the hollow portion 410 is formed to pass through upper and lower surfaces of the base body 41. A front recessed portion 415 is defined between the mounting portion 412 and the retaining walls 413 and has a height greater than a thickness of the main substrate 11. The bottom board 417 is connected between the two retaining walls 413 and located lower than the mounting portion 412. A rear recessed portion 418 is formed between the rear end 411R and the retaining walls 413 and shielded by the base body 41.

As shown in FIG. 1, the engaging member 42 is positioned on the rear end 411R of the base body 41. Preferably, the engaging member 42 integrally extends from the base body 41 through an insert molding process and includes an engaging protrusion 421. Specifically, the engaging protrusion 421 protrudes upward from an upper surface of the engaging member 42 and is block-like in shape. The engaging protrusion 421 is spaced apart from a rear end of the base body 41 so that a holding space 420 is formed between the engaging protrusion 421 and the base body 41.

Referring to FIG. 1 and FIG. 2, as shown in FIG. 2, illustrating a schematic partial assembly view of the optical transmission device 100 of FIG. 1, in assembly, the second connecting unit 4 is firmly mounted to the main substrate 11 of the photonic integrated circuit 1 that allows the waveguide 12 to be positioned on the bottom board 417, and the front end 411F is located on the main substrate 11. The fastening member 35 is detachably engaged with the engaging member 42 to connect the first connecting unit 3 to the second connecting unit 4. In this embodiment, the positioning elements 33 are pin-like in shape to engage with the groove-like attaching portions 416 of the base 11. The fastening member 35 is pushed forward and pressed toward the ferrule element 32 to allow the fastening groove 350 to be in a snap-fit engagement with the engaging protrusion 421, so that a front part of the fastening member 35 is positioned in the holding space 420.

In some embodiments, the engaging member 42 may be omitted to simplify the structure of the second connecting unit 4. In this case, the first connecting unit 3 is connected with the second connecting unit 4 through the engagement between the positioning elements 33 and the attaching portions 416.

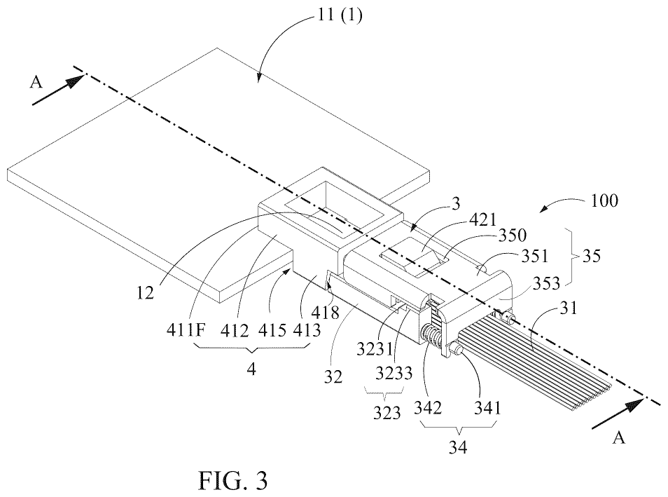

Referring to FIGS. 3 and 4, FIG. 3 is a schematic assembly view of the optical transmission device 100 of FIG. 1, and FIG. 4 is a schematic cross-sectional view taken along line A-A of FIG. 3. As shown in FIG. 3, The second connecting unit 4 is firmly mounted to the main substrate 11 in such a way that the waveguide 12 is positioned between the two retaining walls 413 and extends into the hollow portion 410. The front end 411F and the mounting portion 412 are positioned on the main substrate 11. The front recessed portion 415 is adjacent to the edge 111 and houses portions of the photonic integrated circuit 1. The fastening groove 350 is engaged with the engaging protrusion 421. A front part of the ferrule element 32 is positioned in the rear recessed portion 418 under the rear end 411R of the base body 41.

As shown in FIG. 4, after the first connecting unit 3 is assembled with the second connecting unit 4, with the light source of the optical fibers 31 or the photonic integrated circuit 1 turned on, move the assembled first connecting unit 3 and second connecting unit 4 slightly relative to the main substrate 11 until the maximum light signal is transmitted between the photonic integrated circuit 1 and the applied device connected to the first connecting unit 3, thereby ensuring precise optical alignment between the optical fibers 31 and the waveguide paths 120 of the waveguide 12 (a process known as active alignment). Then, secure the second connecting unit 4 to the main substrate 11, so the first connecting unit 3 can be repeatedly detachably connected with the second connecting unit 4 without affecting the optical alignment between the waveguide paths 120 and the optical fibers 31.

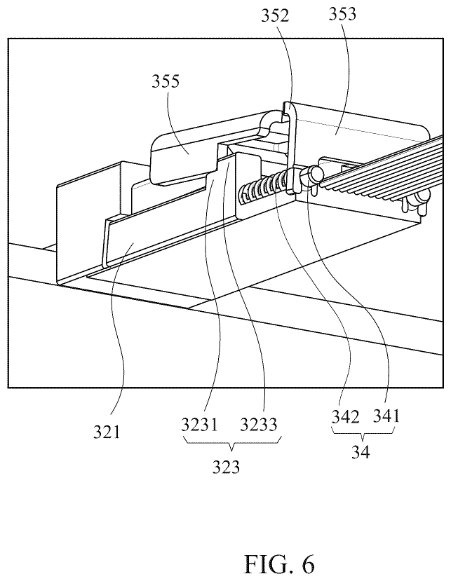

Referring to FIGS. 5 and 6, FIG. 5 is a schematic perspective structural view of the first connecting unit 3, and FIG. 6 is a schematic bottom-to-top rear perspective view of the first connecting unit 3 of FIG. 5. Specifically, the ferrule element 32 includes a main body 321, which includes a plurality of supporting members 323 are positioned spaced apart from each other and extend upward from an upper surface of the main body 321. In detail, each of the supporting members 323 includes a first step portion 3231 and a second step portion 3233 located higher than the first step portion 3231. Each of the limiting members 34 includes a limiting rod 341 and an elastic component 342. Specifically, one end of the limiting rod 341 is connected to a rear side of the ferrule element 32, another end of the limiting rod 341 is connected to a portion of the fastening member 35. The elastic component 342 is positioned around the limiting rod 341 and is abutted between the rear side of the ferrule element 32 and the portion of the fastening member 35, and is deformable in length along the limiting rod 341 in conjunction with movement of the fastening member 35. Preferably, the elastic component 342 is a compressed spring.

Still referring to FIGS. 5 and 6, the fastening member 35 includes a hood portion 351, a linking portion 353, and a bent portion 352 formed between the hood portion 351 and the linking portion 353, and two wing portions 355. Specifically, the hood portion 351, the bent portion 352, and the linking portion 353 are one-piece element and jointly form a substantially inverse L shape and a cantilever structure. The fastening groove 350 is formed to penetrate the hood portion 351. The two wing portions 355 are disposed on opposite sides of the hood portion 351 and bent downward toward the main body 321. As shown in FIG. 5, a rear end of each of the wind portions 355 is retained against the second step portion 3233 such that the hood portion 351 tilts with respect to the ferrule element 321 to enlarge a space between the hood portion 351 and the ferrule element 321 for ease of assembly between the first connecting unit 3 and the second connecting unit 4.

As shown in FIG. 3, after the engaging protrusion 421 is engaged with the hood portion 351 in the fastening groove 350, the rear end of the wing portion 355 is retained in front of the first step portion 3231, while the elastic component 342 applies a push force on a portion of the linking portion 353 to properly secure the engagement between the hood portion 351 and the engaging protrusion 421. In this manner, the first connecting unit 3 can be easily and firmly connected with the second connecting unit 4.

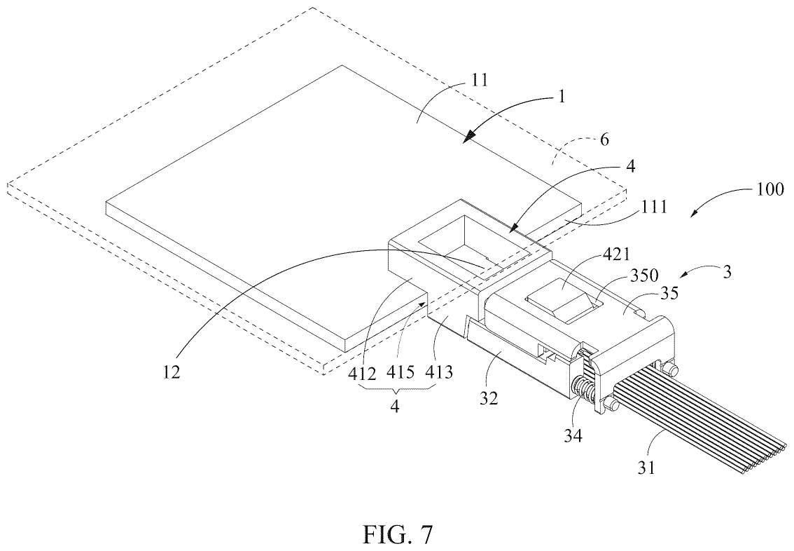

Referring to FIG. 7, it illustrates a schematic perspective view of the optical transmission device 100 in a usage state. A load board 6 is provided to support the photonic integrated circuit 1. The load board 6 may be installed in a photonic integrated circuit, an all-optical device such as all-optical switches, all-optical logic gates, all-optical buffers, or all-optical wavelength converters, or a data processing device such as switches or servers. In some embodiments, the load board 6 may be an optoelectronic substrate equipped with a multi-chip module (MCM) and function as a multi-chip substrate. For example, a plurality of electronic integrated circuits (not shown) and the photonic integrated circuit 1 are mounted on the load board 6 that perform various electrical and optical functions for the data processing device (not shown) and applied devices. As shown in FIG. 7, the front recessed portion 415 is adjacent to the edge 111 and houses portions of the photonic integrated circuit 1 and the load board 6. In some embodiments, the bottom board 417 is disposed on a casing portion of the data processing device or on the load board 6 in the data processing device.

Accordingly, the disclosure provides the photonic integrated circuit including the waveguide integrally protruding from the main substrate, which can eliminate the need for additional lens seats or optical waveguide devices for optical coupling and simplify the structure, thereby overcoming the problem of adhesive overflow caused by stacking lens seats or optical waveguide devices on the main substrate. In addition, the base body of the second connecting unit houses the waveguide for effective protection and is firmly mounted to the photonic integrated circuit through the use of the mounting portion, the retaining wall, and the bottom board, thereby preventing longitudinal and transverse displacement of the waveguide and avoiding damage to the photonic integrated circuit. Furthermore, the engaging member and the fastening member enable a detachable, easy, and reliable connection between the first connecting unit and the second connecting unit, while ensuring precise optical alignment between the waveguide paths and the optical fibers during repeated plugging and unplugging of the optical fibers.

Although the present invention has been disclosed as a preferred embodiment, it is not intended to limit the present invention. Those skilled in the art, without departing from the scope of the present invention, may make various changes or modifications, and thus the scope of the present invention shall be defined by the appended claims and their equivalents.

What is claimed is:

1. An optical transmission device, comprising:
a photonic integrated circuit comprising a main substrate and a waveguide integrally protruding from the main substrate and comprising a plurality of waveguide paths; and
a first connecting unit comprising a plurality of optical fibers and a ferrule element positioned at end portions of the optical fibers; and
a second connecting unit positioned between the main substrate and the first connecting unit, wherein the optical fibers are in optical alignment with the waveguide paths through a detachable connection of the first connecting unit to the second connecting unit.

2. The optical transmission device of claim 1, wherein the waveguide protrudes from an edge of the main substrate and extends into the second connecting unit.

3. The optical transmission device of claim 1, wherein the second connecting unit comprises a base body comprising a front end, a rear end located opposite to the front end, and two retaining walls, the front end located on the main substrate, and the two retaining walls spaced apart from each other and extending downward from a bottom of the base body, wherein a hollow portion is positioned in the base body between the front end, the rear end, and the retaining walls, and the waveguide extends into the hollow portion.

4. The optical transmission device of claim 3, wherein the base body further comprises a plurality of attaching portions disposed on the retaining walls, the first connecting unit further comprises a plurality of positioning elements disposed on the ferrule element, and the positioning elements are sized and shaped to engage with the attaching portions.

5. The optical transmission device of claim 3, wherein the base body further comprises a mounting portion extending from the front end to the retaining walls and positioned on the main substrate.

6. The optical transmission device of claim 5, wherein a front recessed portion is defined between the mounting portion and the retaining walls and has a thickness greater than a thickness of the main substrate.

7. The optical transmission device of claim 5, wherein the base body further comprises a bottom board connected between the two retaining walls and located lower than the mounting portion, and the waveguide is positioned on the bottom board.

8. The optical transmission device of claim 7, wherein the waveguide further comprises an optical coupling surface disposed at an end of the waveguide away from the main substrate, the waveguide paths extend from the optical coupling surface to the main substrate, and the waveguide extends out of the bottom board such that the optical coupling surface is located beyond the bottom board.

9. The optical transmission device of claim 3, wherein the second connecting unit further comprises an engaging member positioned on the rear end of the base body, the first connecting unit further comprises a fastening member movably connected to the ferrule element, and the fastening member is detachably engaged with the engaging member.

10. The optical transmission device of claim 9, wherein the engaging member comprises an engaging protrusion positioned on an upper surface of the engaging member, and the fastening member defines a fastening groove shaped and sized to be in a snap-fit engagement with the engaging protrusion.

11. The optical transmission device of claim 9, wherein the first connecting unit further comprises a limiting rod and an elastic component, one end of the limiting rod is connected to a rear side of the ferrule element, another end of the limiting rod is connected to a portion of the fastening member, wherein the elastic component is positioned around the limiting rod and is abutted between the rear side of the ferrule element and the portion of the fastening member, and is deformable in length along the limiting rod in conjunction with movement of the fastening member.
